(19) United States
(12) Patent Application Publication
(10) Pub. No.: US 2026/0154485 A1
(43) Pub. Date: Jun. 4, 2026

(54) CHIPLET INTEGRATED CIRCUIT (IC) HAVING CENTRAL AND WING CHIPLETS

(71) Applicant: Arm Limited, Cambridge (GB)

(72) Inventors: Deepak Goel, San Jose, CA (US); Anitha Kona, Austin, TX (US); Jamshed Jalal, Austin, TX (US); Roma Rudra, Bangalore (IN); Jeffrey Carl Defilippi, Austin, TX (US)

(21) Appl. No.: 18/967,439

(22) Filed: Dec. 3, 2024

(51) Int. Cl. G06F 30/392; G06F 30/394; G06F 113/18; H01L 25/18

(52) U.S. Cl. CPC G06F 30/392; G06F 30/394; H10W 90/00; G06F 2113/18

(57) ABSTRACT

Briefly, example apparatuses, articles of manufacture, and/or techniques are disclosed that may be implemented, in whole or in part, to implement, facilitate and/or support integrated circuitry comprising a plurality of central chiplets and a plurality wing chiplets.

### FIELD

The present disclosure relates generally to integrated circuitry, and more particularly, chiplet-based integrated circuitry.

### BACKGROUND

In a chiplet-based integrated circuit (IC) multiple individual IC dies (chiplets) may be packaged together to form a unified IC device, which may be known as a “multi-chip module,” “hybrid IC,” “2.5D IC,” “advanced package,” “system-level package,” “system-in-package,” and/or the like. Chiplet technology may provide aspects such as ability to mix-and-match different chiplets in different devices, support for heterogeneous integration (e.g., use of chiplet dies having different pitches, sizes, materials, processes, etc . . . ).

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 illustrates an example device including a package comprising a plurality of chiplets in accordance with an implementation;

FIGS. 2A, 2B, 2C illustrate example systems including a device comprising a plurality of chiplets, in accordance with an implementation;

FIG. 3 illustrates an example wing chiplet comprising an on-chip network in accordance with an implementation;

FIG. 4 illustrates an example device including a package comprising a plurality of chiplets in accordance with an implementation;

FIG. 5 illustrates an example device including a package comprising a plurality of chiplets in accordance with an implementation;

FIG. 6 illustrates an example method of operation, in accordance with an implementation; and

FIG. 7 illustrates an example non-transitory computer-readable medium containing code for fabricating an apparatus, in accordance with an implementation.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others, one or more aspects, properties, etc. may be omitted, such as for ease of discussion, or the like. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular example, implementation and/or embodiment is included in at least one example, implementation and/or embodiment of claimed subject matter. Thus, appearances of such phrases, for example, in various places throughout this specification are not necessarily intended to refer to the same implementation and/or embodiment and/or to any one particular implementation and/or embodiment. Furthermore, it is to be understood that particular features, structures, characteristics, and/or the like described are capable of being combined in various ways in one or more implementations and/or embodiments and, therefore, are within intended claim scope. Unless explicitly indicated to the contrary, reference to “another example” and/or “a further example” does not indicate that the described example is an exclusive alternative to a preceding example. In general, such examples may be alternatives to and/or additions to previous examples.

As used herein, terms referencing cardinal directions (e.g., “north,” “east,” “south,” and “west”) may be used to describe aspects of illustrated components. These terms should be understood as explanatory device to refer to the on-page orientation of the described figure and not any particular physical orientation.

As used herein, the term “chiplet” may refer to one of a plurality of integrated circuits disposed within a common package (a “chiplet package”). Chiplets may implement any type of circuitry, such as processing cores, arithmetic processing units, graphics processing units, application specific ICs (ASICs) such as accelerator cores, analog processing circuitry, analog-to-digital / digital-to-analog converters, networking circuitry, memory circuitry, and/or the like. As a simple example, a chiplet-based processor might comprise a number of chiplets that each implement a plurality of processing cores, a chiplet to implement a memory management unit, and a chiplet-to-chiplet interconnect to provide the processing chiplets access to the memory chiplet. A chiplet may comprise circuitry to execute operational code, such as boot code as described below. In some cases, separate chiplets may be disposed on separate semiconductor dies. Chiplets may be connected in a network within their package via chiplet-to-chiplet interconnects. For example, a chiplet network may operate with relatively lower voltages/power compared to board-level interconnects/networks. In some cases, such a chiplet-to-chiplet interconnect may be contained entirely within the chiplet package (e.g., lacking package contacts). Packages may expose and/or otherwise provide contacts for power and/or package-external signaling. Chiplets may have unique identities and/or operational roles within their package. For example, chiplets may have separate identifiers used for chiplet-to-chiplet communications. In some cases, a package of chiplets may appear as a single device with respect to devices external to the package. In other cases, a chiplet package may appear as separate devices corresponding to groups of one or more chiplets.

In some implementations, chiplets sharing at least a portion of their design may be include in different chiplet packages. For instance, an instance of a video decoder chiplet might be included in a central processing unit (CPU) package along with processing core chiplets, input/output (I/O) chiplets, and the like, while another instance of the video decoder chiplet might be included in a graphics processing unit (GPU). As another example, a chiplet may be designed to be included in a high-performance-computing (HPC) CPU and a standard or low-power CPU. However, different chiplet packages may have various different design requirements for otherwise similar chiplet designs. As another example, it might not be cost-effective to modify a chiplet for a package that is likely to have fewer manufactured units compared to a more common package (e.g., a specialized testing SIP vs a laptop CPU). Additionally, considerations such as die size limitations, chiplet-to-chiplet interconnect length limitations, package-external pin placement requirements, and/or the like may present design challenges for multi-chiplet packages. As indicated above, chiplets may be connected within a package via a chiplet network comprising chiplet-to-chiplet interconnects. Accordingly, chiplets may introduce communication latency in various manners related to network traversal, such as due to traffic traversing one or more chiplets (e.g., introducing network hops), available bandwidth and interconnect speeds between chiplets, and/or the like.

Aspects of the disclosed technology may address challenges such as these by supporting packages comprising central chiplets and wing chiplets. For example, a chiplet package may include a plurality of central chiplets disposed in a central region of the chiplet package. A chiplet package may further include a first wing chiplet neighboring the plurality of central chiplets and disposed in a first peripheral region of the chiplet package, and a second wing chiplet neighboring the plurality of central chiplets and disposed in a second peripheral region of the chiplet package. In some implementations, the plurality of central chiplets are disposed between the first and second wing chiplets. Further aspects of the disclosed technology may address challenges such as these by providing a method of operating a device as described above. Still further aspects of the disclosed technology may provide a computer-readable medium storing computer-readable code for the fabrication of a device as described above and/or a device to function as described above.

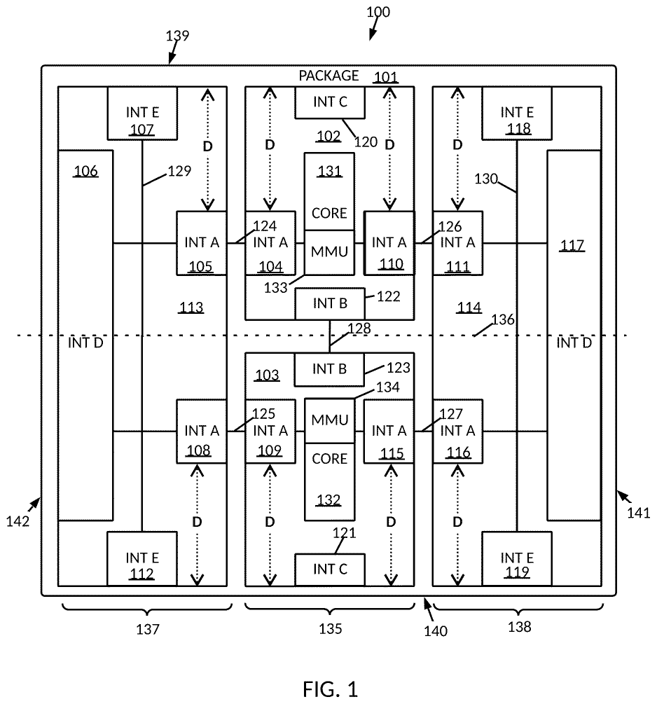

FIG. 1 illustrates an example packaged device comprising a plurality of chiplets including a plurality of central chiplets and a plurality of wing chiplets. In various implementations, a package 101 may comprise any package comprising one or more chiplets (“advanced package”), such as, for example, a multi-chip module, a stacked IC package (“3D IC”), chiplets coupled to a interposer (“2.5D IC”), wafer-level fan-out package, quilted chiplet package, and/or other packaged IC. In various implementations, device 100 may comprise any multi-chip device, such as, for example, an accelerator, micro controller, central processing unit (CPU), graphics processing unit (GPU), memory module, storage device, and/or other computing system component.

In some implementations, device 100 may comprise central chiplets 102, 103 comprising computational cores 131, 132 and communication hubs comprising an on-chip network 129 connecting various interfaces 106, 117; 107, 112; 118, 119. For example, device 100 may comprise a memory bridge supporting a peer-to-peer connection between an accelerator and one or more memory devices.

In some implementations, package 101 may comprise a plurality of central chiplets 102, 103 disposed in a central region 135 of package 101. For example, a plurality of central chiplets 102, 103 may be arranged in a column in central region 135. In some implementations, central chiplets 102, 103 may comprise core circuitry 131, 132. For example, circuitry 131, 132 may comprise one or more computational cores and a memory management unit 133, 134. In various implementations, core circuitry 131, 132 may comprise any number of computational units, such as tens, hundreds, or thousands of computational cores. In further implementations, core circuitry 131, 132 may further comprise digital and/or analog circuitry, such as ASIC circuitry, memory circuitry and general executorial circuitry to store and execute firmware and/or other stored logic, FPGA or other programmable logic circuitry, other combinatorial digital/analog circuitry, and/or combinations thereof.

In some implementations, memory management units (MMUs) 133, 134 may comprise circuitry to manage a system memory address space, conduct memory transactions, such as issuing read and write transactions, performing virtual-to-physical address translation, and/or the like. For example, central chiplets 102, 103 may comprise host devices connected to one or more memory devices providing a pool of memory having a memory address space comprising a physical address space. For instance, as discussed below, chiplets 113 and 114 may comprise interface circuitry 106, 117 for a memory interconnect. In some implementations, a physical address space may be divided between central chiplets 102, 103 as host device. For example, in the illustrated implementation, central chiplet 102, 103 may each host half of the memory address space. Of course, this is merely an example and implementations may distribute the physical address space in any manner.

In some implementations, central chiplets 102, 103 may comprise interface circuitry 120, 121 for a package-external interconnect. For example, circuitry 120, 121 may comprise Peripheral Component Interconnect Express (PCIe) circuitry, Compute Express Link (CXL) circuitry, and/or the like. In some implementations, MMUs 134, 133 may communicate with connected devices over interfaces 120, 121 to provide functions such as Address Translation Services (ATS), Direct Memory Access (DMA), and/or the like. For example, MMUs 133, 134 may support ATS via PCIe root functionality (including, e.g., CXL.io) on interfaces 120, 121. In further implementations, MMUs 133, 134 may implement other functions via interfaces 120, 121, such as, for example, access control, DMA, and/or the like.

In some implementations, central chiplets 102, 103 may comprise interface circuitry 122, 123 for a chiplet to chiplet interconnect 128, such as, for example, a UCIe, UCIe-advanced (UCIe-a), Bunch of Wires (BoW), and/or like interconnect. In some implementations, interconnect 128 may carry north-south communications between central chiplets 102, 103. For example, interconnect 128 may facilitate workloads executed by core circuitry 131, 132 in cooperation. As another example, interconnect 128 may support communications between MMUs 134, 133, such as, for example, virtual address translation for each other's portion of the memory address space, cache-coherency-related communications, and/or the like. In some implementations, interconnect 128 may provide a link between interface 121 and MMU 134 and/or interface 120 and 133. For instance, MMU 133 may provide ATS services to a connected device via interface 120.

In some implementations, package-external interface circuitry 120, 121 may be located at die region proximal to a package boundary 139, 140. For instance, in an implementation where central chiplets 102, 103 are disposed in a north-south columnar arrangement in central region 135, interface circuitry 120, 121 may be located at a north boundary 139 and a south boundary 140, respectively. For example, chiplets 102, 103 may chare a common circuit layout while being disposed in package 101 in different orientations (e.g., rotated by 180°with respect to each other).

In some implementations, package 101 may comprise a plurality of wing chiplets 113, 114 located in peripheral regions 137, 138 at either side of central chiplets 102, 103. In some cases, wing chiplets 113, 114 may be connected to each of central chiplets 102, 103 via chiplet-to-chiplet interconnects 124, 125, 126, 127. For example, wing chiplets 113, 114 may comprise interface circuitry 105, 108, 111, 116 of a chiplet-to-chiplet interconnect, such as, for example, a UCIe, UCIe-advanced (UCIe-a), Bunch of Wires (BoW), and/or like interconnect. Similarly, central chiplets may comprise interface circuitry 104, 110, 109, 115 for chiplet-to-chiplet interconnects 124, 125, 126, 127. For example, wing chiplet 113 and central chiplet 102 may be connected 124 via interface circuitry 105, 104; wing chiplet 113 and central chiplet 103 may be connected 125 via interface circuitry 108, 109; wing chiplet 114 may be connected 126 via interface circuitry 111, 110; and wing chiplet 114 may be connected 127 via interface circuitry 115, 116.

In some implementations, interconnects 124, 126, 125, 127 may support the same die-to-die interconnect protocol and/or parameters as interconnect 128. In other implementations, interconnects 124, 126, 125, 127 may support different die-to-die interconnect protocols and/or parameters compared to interconnect 128. For instance, as discussed below, traffic between wing chiplets 113, 114 (e.g., traffic between interface 107 and interface 117, between interface 112 and interface 106, etc . . . ) may be directed in an east-west manner across one of the central chiplets 102, 103. In some implementations, interconnects 124, 126, 125, 127 may be higher speed and/or bandwidth than interconnect 128. For example, interconnects 124, 126, 125, 127 may comprise semiconductor-bridged interconnects, such as UCIe-advanced interconnects, while interconnect 128 may comprise an unbridged die-to-die interconnect, such as a UCIe-standard interconnect.

In some implementations, wing chiplets 113, 114 may comprise interface circuitry 107, 112, 118, 119 for one or more external communication interconnects, such as Advanced Microcontroller Bus Architecture (AMBA) interconnects (including, e.g., AXI, APB), CXL interconnects, PCIe interconnects, and/or the like. As a particular example, interfaces 107, 112, 118, 119 comprise interfaces for a memory-semantic interconnect, such as CXL. mem and/or CXL. cache.

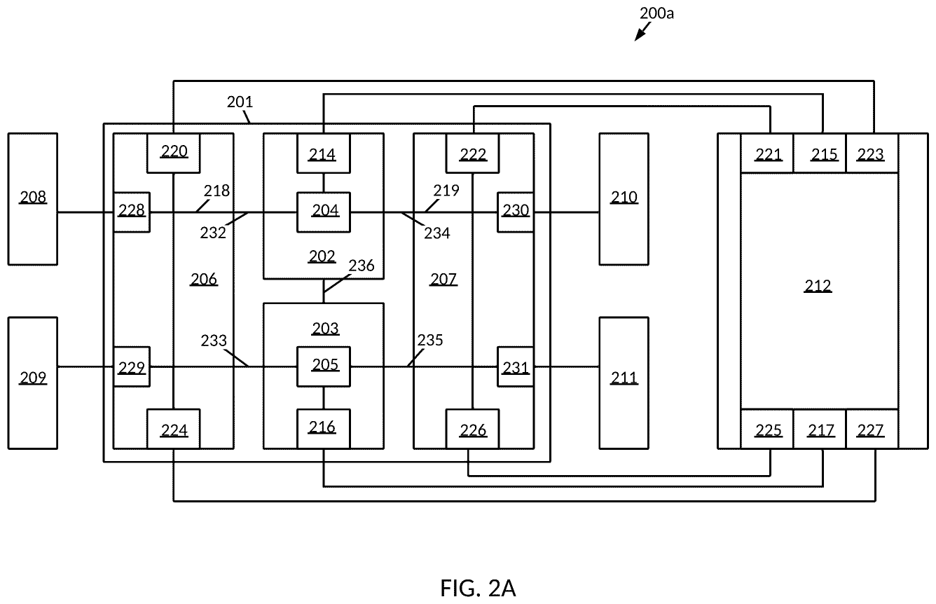

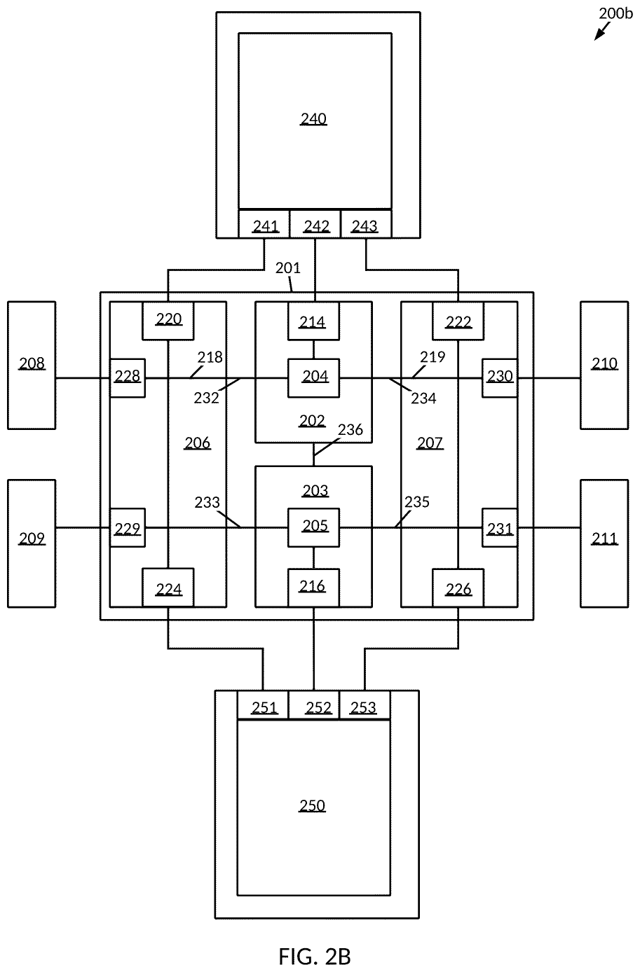

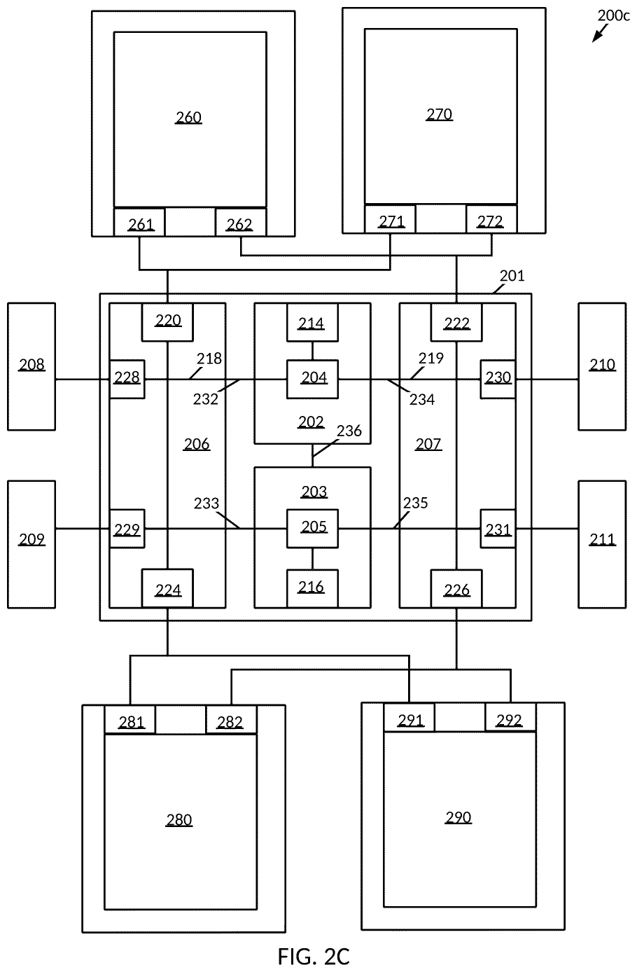

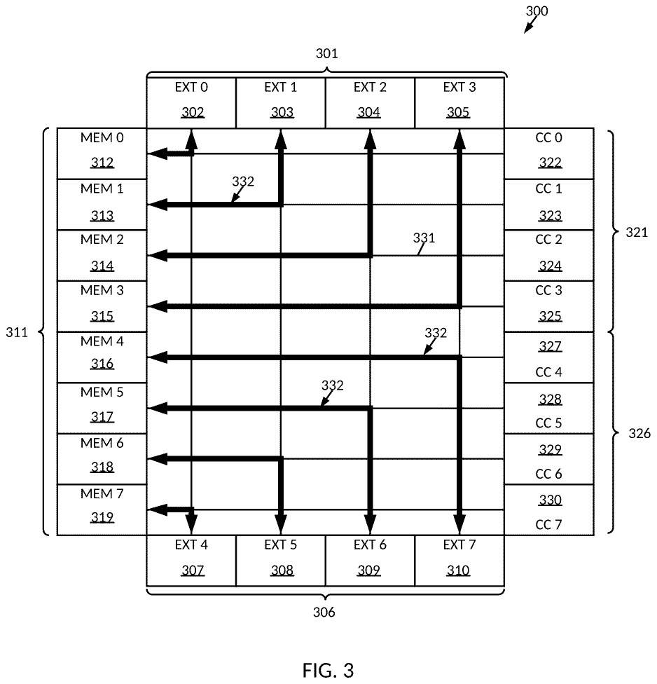

In some implementations, wing chiplets 113, 114 may comprise interface circuitry 106, 117 for one or more memory interconnects. For example, interface circuitry 106, 117 may comprise one or more DDR memory channels. For example, interface 106 may comprise a first memory channel connected to central chiplet 102, and a second memory channel connected to central chiplet 103; similarly, interface 117 may comprise a first memory channel connected to central chiplet 102 and a second memory channel connected to central chiplet 103 (see, e.g., FIGS. 2A-2C, 3). For instance, device 100 may provide a cache-coherent bridge to a memory system. For example, wing chiplets 113, 114 may comprise on-chiplet networks 129, 130 interconnecting package-external interfaces 107, 118, 112, 119, package-external memory interfaces 106, 117, and chiplet-to-chiplet interfaces 105, 108, 111, 116. In some implementations, networks 129, 130 may be interconnected via central chiplets 102, 103 and communications (e.g., memory read/write requests and responses, compute-in-memory operational requests etc . . . ) from each interfaces 107, 118, 112, 119 may be transported to either interface 106, 117. For example, memory transactions communications may be routed by wing chiplets between package-external interfaces 107, 118, 112, 119 and package-external memory interfaces 106, 117 in a peer-to-peer manner independently of MMUs 133, 134. As an example, FIG. 3 illustrates traffic across example implementations of networks 129, 130.

In some implementations, wing chiplets 113, 114 may be sized to span respective peripheral regions 137, 138 such that a single wing chiplet 113, 114 has a height (e.g., north-south length) corresponding to the combined height of central chiplets 102, 103. For example, wing chiplets 113, 114 may have heights corresponding to a maximum die-size of a manufacturing process for device 100 (e.g., 33 mm) and central chiplets may have heights bounded by the maximum die-size divided by the number of central chiplets. For instance, in an example of two central chiplets 102, 103 and a maximum die-length of 33 mm, central chiplets 102, 103 may have heights of 16.5 mm or less.

In some implementations, interfaces of different types may have different sizes. For instance, an interface 107, 112, 118, 119 for a serial interconnect (e.g., an AMBA, CXL, PCIe interface and/or the like) may have a smaller physical width than an interface 106, 117 for a parallel interconnect (e.g., a DDR5 and/or other DDR-type interface). In some cases, interfaces 107, 118 and 112, 119 may be located at narrower edges of wing chiplets 113, 114 (e.g., at north boundary 139 and south boundary 140, respectively). Similarly, interfaces 106, 117 may be located at longer edges proximal to a package 101 boundary (e.g., west boundary 142 and east boundary 141, respectively).

In some implementations, wing chiplets 113, 114 may share aspects of their design and/or floorplan/layout. For instance, wing chiplets 113, 114 may be instances of a common design with interfaces arranged so that wing chiplet instances of a common design may be located on either side of central chiplets 102, 132. For example, an implementation as illustrated in FIG. 1 may comprise a first pair of central chiplets 102, 103 sharing a design and a second pair of chiplets 113, 114 that share a second design. In some implementations, chiplets sharing a design may be rotated and/or translated with respect to each other. For instance, central chiplets 102 and 103 may be rotated by 180° with respect to each other. Similarly, wing chiplets 113, 114 may be rotated by 180° with respect to each other.

In some implementations, interfaces 105, 104, 108, 109, 110, 111, 115, 116 may be located in a symmetric manner with respect to a wing chiplet midline 136. For instance, interfaces 05, 104, 108, 109, 110, 111, 115, 116 may be located a common distance D from the edges distal from midline 136. Additionally, in some implementations, interfaces 105, 108 and 111, 115 may have reflected layouts (e.g., reflected over midline 136). For example, the reflected layouts may accommodate the opposite orientations of central chiplets 102, 103 in implementations where these chiplets share a common design. As an example, package 101 may comprise a first pair of instances 102, 103 of a first chiplet design (e.g., a central chiplet design) and a second pair of instances 113, 114 of a second chiplet design (e.g. a wing chiplet design).

FIG. 2A illustrates an example system 200a comprising a chiplet-based device 201, an accelerator 212, and memory 208, 209, 210, 211, in accordance with an implementation. As an example, system 200a may comprise an accelerator 212 connected to a plurality of memory devices 208, 209, 210, 211 via chiplet device 201.

In some implementations, device 201 may comprise a plurality of central chiplets 202, 203 disposed in a central region of a package and a plurality of wing chiplets 206, 207 disposed in peripheral regions of the package. For example, central chiplets 202, 203 may comprise implementations of central chiplets 102, 103 of FIG. 1, while wing chiplets 206, 207 may comprise implementations of wing chiplets 113, 114. In some implementations, chiplets 202, 203 may comprise MMUs 204, 205 to manage a memory address space provided by memory 208, 209, 210, 211. For example, memory 208, 209, 210, 211 may comprise one or more memory modules external to device 201. In some examples, MMUs 204 and 205 may manage portions of a memory address space. For instance, MMU 204 may manage memory addresses corresponding to memory devices 208, 210, while MMU 205 may manage memory addresses corresponding to memory devices 209, 211.

In some implementations, system 200a may comprise an accelerator 212 connected to chiplet device 201. For example, accelerator 212 may comprise an ASIC 212 or other circuitry to perform various workloads, such as an artificial intelligence (AI) accelerator, neural processing unit, visual processing unit, digital signal processor, or any other workload acceleration circuitry. In some implementations, ASIC 212 may retrieve data from memory 208, 209, 210, 211 via chiplet device 201. For example, chiplet device 201 may comprise a memory bridge for accelerator 212.

In some implementations, accelerator 212 may be connected to central chiplets 202, 203 via interfaces 214, 215, 216, 217. For example, interfaces 214, 215, 216, 217 may comprise PCIe interfaces and/or other interfaces providing a device-to-device interconnect. Accelerator 212 may conduct various communications using interfaces 215, 217. For example, accelerator 212 may operate on data that is assigned virtual memory addresses and may request address translation services from MMUs 204, 205 to translate these virtual addresses to physical memory addresses. As another example, chiplets 202, 203 may comprise processor chiplets 202, 203 which may use interfaces 214, 216 to transmit workload instructions to accelerator 212 and/or to receive workload results.

In some implementations, accelerator 212 may be connected to a plurality of wing chiplets 206, 207 via connected interfaces 220-221, 222-223, 224-225, 226-227. For example, interfaces 220, 222, 224, 226 may be implemented as described with respect to interfaces 107, 118, 112, 119 of FIG. 1. In some implementations, wing chiplets 206, 207 may provide various paths for accelerator 212 to read/write or perform other operations with respect to memory 208, 209, 210, 211. In some implementations, wing chiplets 206, 207 may comprise interfaces 220, 224, 222, 226 corresponding to direct paths to memory 208, 209, 210, 211. Wing chiplets 206, 207 may further provide indirect paths between interfaces 220, 222, 224, 226 and other memory (e.g., an indirect path between interface 220 and memory 210, etc . . . ). For example, wing chiplets 206, 207 may comprise on-chip networks 218, 219 connected to central chiplets, 202, 205 via chiplet-to-chiplet interconnects 232, 233, 234, 235.

In some implementations, wing chiplets 206, 207 may route north-south communications via on-chip networks 218, 219 and may route east-west communications via chiplets 202, 203. For example, a memory read request received at interface 222 but having an address corresponding to memory 209 may be routed from interface 222 through chiplet-to-chiplet interconnects 235, 233 to interface 229. As another example, a request received at interface 220 for a physical address at memory 211 may be routed across chiplet-to-chiplet interconnects 232, 234 and across network 219 to interface 231. In some implementations, a central chiplet-to-chiplet interconnect 236 may be a different type of interconnect compared to interconnects 232, 233, 234, 235. For instance, interconnects 232, 233, 234, 235 may be sized for a greater volume of communications compared to interconnect 236. For instance, interconnect 236 may be a standard UCIe interconnect and interconnects 232, 233, 234, 235 may be UCIe-advanced interconnects.

In some implementations, accelerator 212 may utilize a particular interface 221, 223, 225, 227 based, at least in part, on memory physical addresses. For example, memory requests with respect to memory 208 might be transmitted via link 220-223, memory requests with respect to memory 209 might be transmitted via link 224-225, memory requests with respect to memory 210 might be transmitted via link 222-221, and memory requests with respect to memory 211 might be transmitted via link 226-225. For example, this may provide non-blocking paths to different memory without latency incurred via network hops over chiplets 202, 203. As another example, accelerator 212 might utilize links 220-223, 224-227 for either memory 208 or memory 209 and might utilize links 222-221, 226-225 for either memory 210 or memory 211. For example, this may also provide paths to different memory without latency incurred via network hops over chiplets 202, 203. Accordingly, device 201 may provide a bridge from any interface 220, 222, 223, 226 to any memory 208, 209, 210, 211 while providing lower-latency channels corresponding to particular groupings of interface and memory.

FIG. 2B illustrates an example system 200b comprising two accelerators 240, 250 connected to chiplet-based device 201, in accordance with an implementation. As illustrated, a first accelerator 240 may comprise interface circuitry 242 to connect to interface 214 of central chiplet 202 and a second accelerator 250 may comprise interface circuitry 252 to connect to interface 216 of central chiplet 203. For example, chiplet 240 may request address translation services from MMU 204 directly and may request address translation services from MMU 205 indirectly via chiplet-to-chiplet interconnect 236. Similarly, chiplet 250 may request address translation services from MMU 205 directly and may request address translation services from MMU 204 indirectly. In further implementations, accelerators 240, 250 may be connected to interfaces 214, 216 in other manners. For instance, interfaces 214 and 216 may comprise a plurality of channels (e.g., lanes) that may be divided between devices, and each accelerator 240, 250 may be connected to each interface 214, 216.

In the illustrated example, a first accelerator 240 may comprise interface circuitry 241 to connect to interface 220 of east wing chiplet 206 and may comprise interface circuitry 243 to connect to interface 222 of west wing chiplet 207. Similarly, a second accelerator 250 may comprise interface circuitry 251 to connect to interface 224 of east wing chiplet 206 and may comprise interface circuitry 253 to connect to interface 226 of west wing chiplet 207. Accordingly, each accelerator 240, 250 may have a direct path (e.g., paths that traverse a single wing chiplet) to each memory 208, 209, 210, 211 and indirect paths (e.g., paths that traverse both wing chiplets 206, 207 and a central chiplet 202, 203) to each memory 208, 209, 210, 211.

FIG. 2C illustrates an example system 200b comprising four accelerators 260, 270, 280, 290 connected to chiplet-based device 201, in accordance with an implementation. In some implementations, accelerators 260, 270, 280, 290 may be connected to central chiplets 202, 203 via interfaces 214, 216. However, for clarity of illustration, these links are not illustrated. In the illustrated example, a first accelerator 260 and a second accelerator 270 may comprise interface circuitry 261, 271 to connect to interface 220 of east wing chiplet 206 and may comprise interface circuitry 262, 272 to connect to interface 222 of west wing chiplet 207. Similarly, a third accelerator 280 and a fourth accelerator 290 may comprise interface circuitry 281, 291 to connect to interface 224 of east wing chiplet 206 and may comprise interface circuitry 282, 292 to connect to interface 226 of west wing chiplet 207. For example, interface circuitry 220, 22, 224, 226 may comprise multiple channels, links, lanes, and/or the like which may be divided between accelerators 260, 270; 280, 290. Accordingly, each accelerator 260, 270, 280, 290 may have a direct path (e.g., paths that traverse a single wing chiplet) to each memory 208, 209, 210, 211 and indirect paths (e.g., paths that traverse both wing chiplets 206, 207 and a central chiplet 202, 203) to each memory 208, 209, 210, 211. In further implementations, accelerators 260, 270, 280, 290 may be connected to device 201 in various other manners. In some implementations, each accelerator 260, 270, 280, 290 may be connected to a single corresponding interface 220, 222, 224, 226. For example, this accelerators 260, 270, 280, 290 with a wider interface while reducing the number of direct paths between a given accelerator and memory 208, 209, 210, 211. For instance, if accelerator 280 were a single device connected to interface 224 (e.g., if accelerator 280 were not connected to interface 226), accelerator 280 may have a relatively wider interface with direct paths to memory 208, 209 and indirect paths to memory 210, 211.

FIG. 3 illustrates an example wing chiplet 300 in accordance with an implementation. For example, wing chiplet 300 may comprise an implementation of wing chiplets 113, 114 of FIG. 1, wing chiplets 206, 207 of FIGS. 2A-2C, and/or any other wing chiplet described herein. However, for ease of explanation, wing chiplet 300 is illustrated in an orientation similar to and described as an implementation of wing chiplets 113 and 206.

In some implementations, wing chiplet 300 may comprise interface circuitry 301, 306 for a package-external peripheral interconnect. For example, interface circuitry 301, 306 may be implemented as described with respect to interface circuitry 107, 112, 118, 119 of FIG. 1, interface circuitry 220, 224, 222, 226 of FIG. 2, and/or any other similar interface described herein. In some implementations, interface circuitry 301, 306 may comprise link circuitry 302, 303, 304, 305, 307, 308, 309, 310 for a plurality of channels links, lanes, and/or the like. As a particular example, each link circuitry 302-305, 307-310 may comprise circuitry for an 8-lane AMBA link, CXL link, PCIe link, and/or the like. In various implementations, chiplet 300 may support connections to any combination of connected devices. For example, as illustrated with respect to FIG. 2A, each link 302-305, 307-310 may be connected to a single accelerator or other device. As another example, as illustrated with respect to FIG. 2B, links 302-305 of interface circuitry 301 may be connected to a first device and links 307-310 of interface circuitry 306 may be connected to a second device. As a further example, such as illustrated with respect to FIG. 2C, a first subset of links 302-305 may be connected to a first device and a second subset of links 302-205 may be connected to a second device. Similarly, in this example, a first subset of links 307-310 may be connected to a third device and a second subset of links 307-310 may be connected to a fourth device.

In some implementations, wing chiplet 300 may comprise interface circuitry 311 for a memory interconnect. For example, interface circuitry 311 may comprise an implementation of interface circuitry 106, 117 of FIG. 1, interface circuitry 228, 229, 230, 231 of FIGS. 2A-2C, and/or any other memory interface circuity described herein. In some implementations, interface circuitry 311 may comprise interface circuitry 312-319 for a corresponding plurality of memory channels. For example, circuitry 312-319 may comprise DDR5 (or other DDR type) media controller circuitry 312-319. In some implementations, the number of memory channel circuits 312-319 may correspond to the number of peripheral interconnect link circuits 302-305, 307-310. In further implementations, the number of memory channel circuits 312-319 may be different from the number of link circuits 302-305, 312-319.

In some implementations, wing chiplet 300 may comprise interface circuitry 321, 326 for a chiplet-to-chiplet interconnect. For example, interface circuitry 321, 326 may comprise implementations of interface circuitry 105, 108, 111, 116 of FIG. 1 and/or any other interface for a chiplet-to-chiplet interconnect. In some cases, interface circuitry 321 may be connected to corresponding interface circuitry of a first central chiplet and interface circuitry 326 may be connected to corresponding interface circuitry of a second central chiplet, such as described with respect to interconnects 124, 125, 126, 127 of FIG. 1. In some implementations, interface circuitry 321 may comprise a plurality of interface circuits 322, 323, 324, 325 and interface circuitry 326 may comprise a plurality of interface circuits 327, 328, 329, 330. In such implementations, chiplet-to-chiplet interface circuitry of connected central chiplets may comprise a corresponding plurality of interface circuits. For example, circuits 322-325, 327-330 may comprise UCIe-advanced interconnect circuits.

As indicated above, a wing chiplet 300 may have a design that supports placement in a package in a first orientation or a second orientation. As an example with respect to FIG. 1, wing chiplet 300 may be capable of acting as an east wing chiplet 113 and/or a west wing chiplet 114. Further, a first chiplet connected via interface circuitry 321 may be rotated by 180° with respect to a second chiplet connected via interface circuitry 326. In some implementations, interconnect contacts of circuitry 321 may be reflected with respect to contacts of circuitry 327-330. For example, a first central chiplet in a first orientation and a second central in a rotated orientation may have reflected chiplet-to-chiplet contacts. Accordingly, circuity 321 may be orientated to connect to a first central chiplet in a first orientation and circuitry 326 may be orientated to connect to a second central chiplet in a rotated orientation. In further implementations, interface circuitry 321 and interface circuitry 326 may have the same orientation. For example, a chiplet-to-chiplet interconnect protocol may include support for non-matching interfaces on each side of the interconnect (e.g., for cross-over connections).

In some implementations, wing chiplet 300 may comprise an on-chiplet network 331. For example, network 331 may be an implementation of networks 129, 130 of FIG. 1, networks 218, 219 of FIGS. 2A-2C, and/or any other wing chiplet network described herein. In various implementations, network 331 may have any suitable topology. As an example, chiplet 300 may comprise a cross-bar network 331 interconnecting interface circuits 302-305, 312-319, 307-310, 322-325, 327-330. As illustrated, cross-bar network 331 may provide direct, non-blocking paths 332 between external interface circuits 302-305, 307-310 and corresponding memory interface circuits 312-319 (e.g., interface circuit 310 may have a direct, non-blocking path 332 to memory interface circuit 316). In some implementations, cross-bar network 331 may provide direct (e.g., single chiplet) paths between any of interface circuits 302-305, 307-310 to any of memory interface circuits 312-319. Additionally, cross-bar network 331 may provide indirect (e.g., multiple chiplet) paths between any of interface circuits 302-305, 307-310 to any memory interface circuits of a second wing chiplet (not pictured) via central chiplets (not pictured), such as described with respect to traffic crossing central chiplets 102, 103 of FIG. 1. In further implementations, network 331 may have any other suitable topology and/or may comprise any suitable type of on-chip network.

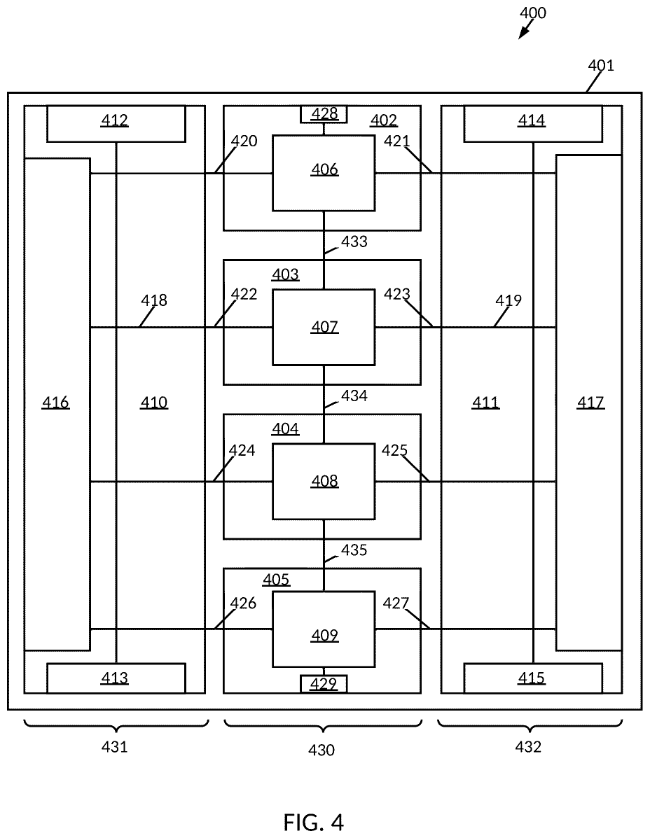

FIG. 4 illustrates an example chiplet-based device 400 in accordance with an implementation. For example, device 400 may comprise an implementation of a device 100 of FIG. 1, a device 201 of FIGS. 2A-2C, and/or any other chiplet-based device described herein. As discussed above, a device 400 may comprise a plurality of central chiplets 402, 403, 404, 405 disposed in a central region 430 of a package 401. In various implementations, a device 400 may comprise any number of central chiplets. For instance, in the example of FIG. 4, central region 430 may comprise four central chiplets 402, 403, 404, 405. In some implementations, a plurality of central chiplets 402-405 may be arranged in a columnar layout, as illustrated. In further implementations, a plurality of central chiplets 402-405 may be arranged in various layouts. For example, an implementation may comprise chiplets arranged in a two column arrangement, grid, and/or the like.

In some implementations, central chiplets 402-405 may comprise computational circuitry 406, 407 408, 409, such as, for example a general-purpose processing unit, a graphical processing unit, and/or other ASIC. Additionally, as discussed with respect to interconnect 128, device 400 may comprise chiplet-to-chiplet interconnects 433, 434, 435 connecting central chiplets 402-405. In some cases, computational circuitry 406-409 may comprise MMU circuitry. In some implementations, each chiplet 402-405 may be a host device for a portions of a memory address space, such as described with respect to central chiplets 102, 103 and MMUs 133, 134 of FIG. 1. Additionally, one or more chiplets 402-405 may provide ATS for one or more accelerators or other device connected via peripheral interfaces 412, 413, 414, 415. In some implementations, a central chiplet 402, 405 disposed on a border of package 401 may comprise a package-external interface 428, 429. For example, interfaces 428, 429 may comprise PCIe interfaces or other interface for a protocol supporting ATS.

In some implementations, device 400 may comprise a plurality of wing chiplets 410, 411 disposed in peripheral regions 431, 432 of package 401. For example, wing chiplets 410, 411 may comprise implementations of wing chiplets 113, 114 of FIG. 1, wing chiplets 206-207 of FIGS. 2A-2C, wing chiplet 300 of FIG. 3, and/or any other wing chiplet described herein. For example, wing chiplets 410, 411 may comprise a plurality of package-external peripheral interfaces 412, 413, 414, 415 and memory interfaces 416, 417. Additionally, device 400 may comprise chiplet-to-chiplet interconnects 420, 422, 424, 426, 421, 423, 425, 427 connecting each wing chiplet 410, 411 to each central chiplet 402, 403, 404, 405, respectively.

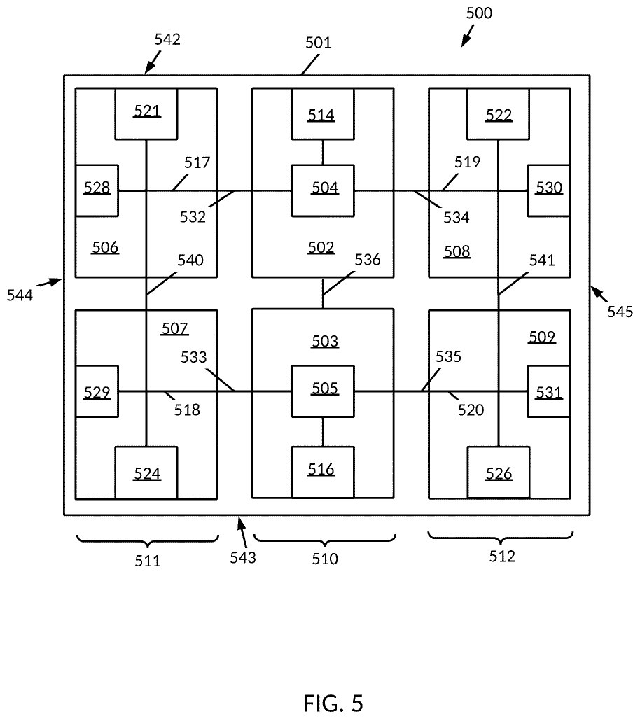

FIG. 5 illustrates an example chiplet-based device 500 in accordance with an implementation. For example, device 500 may comprise an implementation of a device 100 of FIG. 1, a device 201 of FIGS. 2A-2C, a device 400 of FIG. 4, and/or any other chiplet-based device described herein. As discussed above, a device 500 may comprise a plurality of wing chiplets 506, 507, 508, 509 disposed in peripheral regions 511, 512 on either side of a plurality of central chiplets 502, 503 disposed in a central region 510 of a package 501. For instance, in the example of FIG. 5, central region 510 may comprise a pair central chiplets 502, 503 and each peripheral region 511, 512 may comprise a corresponding pair of wing chiplets 506, 507; 508, 509.

In some implementations, central chiplets 502, 503 may be implemented as described with respect to central chiplets 102, 103 of FIG. 1, central chiplets 202, 203 of FIGS. 2A-2C, central chiplets 402-405 of FIG. 4, and/or any other central chiplet described herein. For example, central chiplets 502, 503 may comprise package-external interface circuitry 514, 516 implemented as described with respect to interface circuitry 120, 121; 214, 216 and/or 428, 429. Similarly, central chiplets 502, 503 may comprise circuitry for a chiplet-to-chiplet interconnect 536 implemented as described with respect to circuitry and interconnect 122, 123, 128; interconnect 236; and/or interconnects 433, 434, 435.

In some implementations, a subset of wing chiplets 506, 507, 508, 509 disposed in a peripheral region 511, 512 may be connected via chiplet-to-chiplet interconnects 532, 533, 534, 535 to a corresponding subset of central chiplets 502, 503. For example, in the example of FIG. 5, wing chiplet 506 and wing chiplet 508 may be connected to central chiplet 502 via chiplet-to-chiplet interconnects 532, 534, respectively. Similarly, wing chiplet 507 and wing chiplet 509 may be connected to central chiplet 503 via chiplet-to-chiplet interconnects 533, 535, respectively. As an example, wing chiplets 506, 507, 508, 509 and central chiplets 502, 503 may have equal die dimensions. For instance, wing chiplets 506, 507, 508, 509 and central chiplets 502, 503 may have equal heights. In some implementations, wing chiplets 506, 507, 509 may share various aspects of their design. For instance, wing chiplets 506, 509 may have a common design and wing chiplets 508, 507 may have a common design. In some cases, the circuit layouts of wing chiplets 506, 509 and wing chiplets 507, 508 may be mirror images of each other.

In some implementations, each wing chiplet 506, 507, 508, 509 may comprise interface circuitry 521, 524, 522, 526 for a package-external interconnect. For example, interface circuitry 521, 524, 522, 526 may be implemented as described with respect to interface circuitry 107, 112, 118, 119 of FIG. 1, interface circuitry 220, 224, 222, 226 of FIGS. 2A-2C, interface circuitry 301, 306 of FIG. 3, interface circuitry 412, 413, 414, 415, and/or any other wing chiplet peripheral interface described herein. For example, each wing chiplet 506, 507, 508, 509 may be laid out so that each interface 521, 524, 522, 526 is proximal to a corresponding nearest package boundary 542, 543.

In some implementations, each wing chiplet 506, 507, 508, 509 may comprise interface circuitry 528, 529, 530, 531 for memory interconnects. For example, interface circuitry 528, 529, 530, 531 may be located at respective package boundaries 544, 545 and may be implemented as described with respect to memory interconnect interface circuitry 106, 117 of FIG. 1; circuitry 228, 229, 230, 221 of FIGS. 2A-2C; circuitry 311 of FIG. 3, circuitry 416, 417 of FIG. 4, and/or any other memory interconnect interface circuitry described herein. As a particular example, interface circuitry 528, 531 may comprise a first plurality of memory link circuits 312-315 and interface circuitry 529, 530 may comprise a second plurality of memory link circuits 316-319 as described with respect to FIG. 3.

In some implementations, wing chiplets 506, 507 and 508, 509 may be connected via interconnects 540, 541. For example, interconnect 540 may connect a first on-chip network 517 and a second on-chip network 518 of wing chiplets 506, 507 disposed in a first region 511. Similarly, interconnect 541 may connect a third on-chip network 519 and a fourth on-chip network 520. In some implementations, interconnects 540, 541 may provide paths for north-south communication traffic between chiplets 506, 507 and 508, 509, respectively. In some cases, interconnects 540, 541 may be of a same type of interconnects 532, 533, 524, 526, such as, for example, UCIe-advanced interconnects.

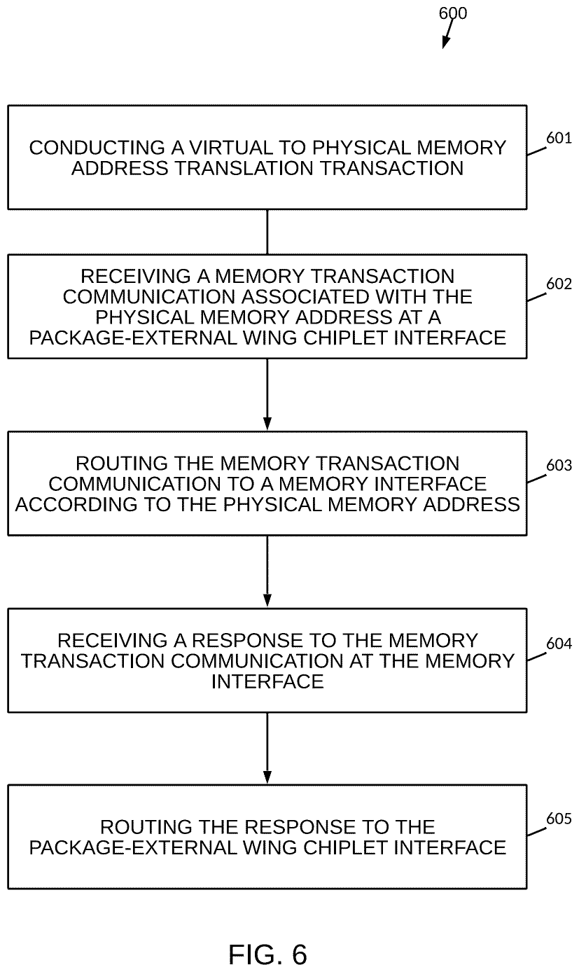

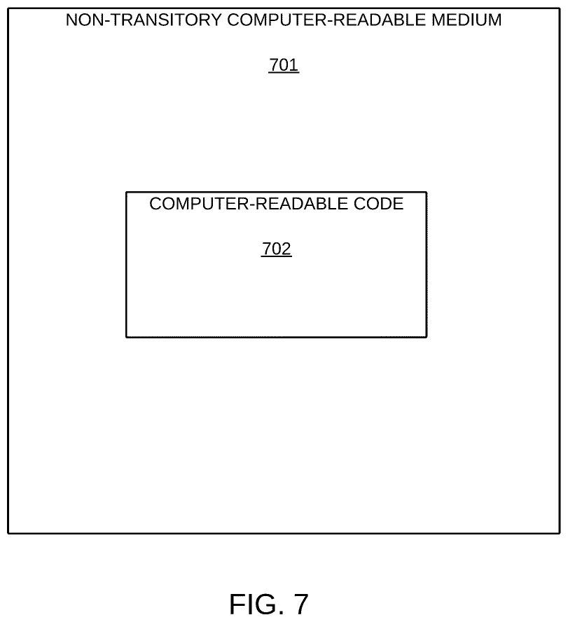

FIG. 6 illustrates a method 600 of operation, such as of devices implemented as described with respect to FIGS. 1-5. For example, method 500 may be performed by a chiplet-based device comprising a plurality of central chiplets disposed in a central region of a package and a plurality of wing chiplets disposed in peripheral regions of the package.

In some implementations, method 600 may include operation 601, which may include conducting a virtual-to-physical memory address translation transaction. For example, operation 601 may comprise a central chiplet receiving a virtual memory address in a virtual to physical memory address translation request. Operation 601 may further comprise responding to the virtual to physical memory address translation request. For example, operation 601 may be performed by a central chiplet via a package-external interface. For example, operation 601 may be performed as described with respect to central chiplets 102, 103 performing address translation services via package-external interfaces 120, 121. As another example, operation 601 may be performed in response to a request transmitted by a connected accelerator, such as described with respect to accelerator 212, accelerators 240, 250, and/or accelerators 260, 270, 280, 290 of FIGS. 2A-2C. For instance, operation 601 may be conducted according to an address translation service protocol, such as a PCIe ATS protocol.

In some implementations, method 600 may further include operation 602, which may comprise receiving a memory transaction communication. For example, the memory transaction communication may be associated with the physical address provided in operation 601. In some implementations, operation 602 may be performed by a wing chiplet via a package-external interface. For instance, operation 602 may be performed by a wing chiplet 113, 114 via an interface 107, 112, 118, 119 as described with respect to FIG. 1. As another example, operation 602 may be performed as described with respect to a wing chiplet 206, 207, a wing chiplet 300, a wing chiplet 410, 411, and/or a wing chiplet 506, 507, 508, 509. As indicated above, in various implementations, a memory transaction communication may comprise a memory read request, a memory write request, a cache-coherency protocol request, and/or other like memory request, such as provided by AMBA, CXL, PCIe, and/or like protocols.

In some implementations, method 600 may further include operation 603, which may include routing the memory transaction communication to a memory interface for a memory interconnect. For example, operation 603 may comprise routing the communication across an on-chip network of the wing chiplet at which the communication was received. For instance, operation 603 may be performed as described with respect to operation of wing chiplet 300 and on-chip network 331 of FIG. 3. As another example, operation 603 may comprise routing the memory transaction communication from a first wing chiplet to a second wing chiplet across an intermediary central chiplet. For example, operation 603 may be performed as described with respect to communication traffic traversing central chiplets 102, 103 between wing chiplets 113, 114 of FIG. 1. As a further example, operation 603 may be performed as described with respect to systems 200a, 200b, 200c of FIGS. 2A-2C. In some implementations, operation 603 may further comprise transmitting the memory transaction communication to a memory system corresponding to the physical address. As an example, operation 603 may comprise transmitting the memory transaction communication via a memory interface such as memory interface 311 of FIG. 3. For instance, operation 603 may comprise transmitting the memory transaction communication via a memory link interface 312-319 that corresponds to the physical memory address.

In some implementations, method 600 may further include operation 604, which may include receiving a response to the memory transaction via the memory interface. For example, operation 604 may comprise receiving data responsive to a memory read request, a cache-coherency request, and/or the like. As another example, operation 601 may comprise receiving an acknowledgment message, completion message, and/or the like responsive to a memory write request, a compute-in-memory request, and/or the like. As an example, operation 603 may comprise receiving the memory transaction response via a memory interface such as memory interface 311 of FIG. 3. For instance, operation 603 may comprise receiving the memory transaction responsive via a memory link interface 312-319 that was used to send a memory transaction request in operation 603.

In some implementations, method 600 may further include operation 605, which may include routing the response to the package-external wing chiplet interface at which the transaction was received in operation 602. In some implementations, the response may be routed via the same path as operation 602. In further implementations, the response may be routed via a different path. As an example with respect to FIG. 2B, a request from accelerator 250 that was received at interface 224 may be routed to memory interface 230 across one of central chiplets 202, 203 and the response may be routed across another one of central chiplets 202, 203 (e.g., a request may be routed across central chiplet 203 and a response may be routed across central chiplet 202). In some implementations, operation 605 may further comprise transmitting the response via the package external interface.

FIG. 6 illustrates an example of a non-transitory computer-readable medium 701 comprising computer-readable code 702. Concepts described herein may be embodied in computer-readable code 702 for fabrication of an apparatus that embodies the described concepts. For example, the computer-readable code 702 can be used at one or more stages of a semiconductor design and fabrication process, including an electronic design automation (EDA) stage, to fabricate an integrated circuit comprising the apparatus embodying the concepts. The above computer-readable code 702 may additionally or alternatively enable the definition, modeling, simulation, verification and/or testing of an apparatus embodying the concepts described herein.

For example, the computer-readable code 702 for fabrication of an apparatus embodying the concepts described herein can be embodied in code 702 defining a hardware description language (HDL) representation of the concepts. For example, the code 702 may define a register-transfer-level (RTL) abstraction of one or more logic circuits for defining an apparatus embodying the concepts. The code 702 may define an HDL representation of the one or more logic circuits embodying the apparatus in Verilog, SystemVerilog, Chisel, or VHDL (Very High Speed Integrated Circuit Hardware Description Language) as well as intermediate representations such as FIRRTL. Computer-readable code 702 may provide definitions embodying the concept using system-level modeling languages such as SystemC and SystemVerilog or other behavioral representations of the concepts that can be interpreted by a computer to enable simulation, functional and/or formal verification, and testing of the concepts.

Additionally or alternatively, the computer-readable code 702 may define a low level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code 702 a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code 702 may comprise a mix of code 702 representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code 702 defining instructions which are to be executed by the defined apparatus once fabricated.

Such computer-readable code 702 can be disposed in any known transitory computer-readable medium (such as wired or wireless transmission of code over a network) or non-transitory computer-readable medium 701 such as semiconductor, magnetic disk, or optical disc. An integrated circuit fabricated using the computer-readable code 702 may comprise components such as one or more of a central processing unit, graphics processing unit, neural processing unit, digital signal processor or other components that individually or collectively embody the concept.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Furthermore, it is intended, for a situation that relates to implementation of claimed subject matter and is subject to testing, measurement, and/or specification regarding degree, to be understood in the following manner. As an example, in a given situation, assume a value of a physical property is to be measured. If alternatively reasonable approaches to testing, measurement, and/or specification regarding degree, at least with respect to the property, continuing with the example, is reasonably likely to occur to one of ordinary skill, at least for implementation purposes, claimed subject matter is intended to cover those alternatively reasonable approaches unless otherwise expressly indicated.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

Some configurations of the present techniques are described by the following numbered clauses:

Clause 1: A device, comprising:
a chiplet package;
a plurality of central chiplets disposed in a central region of the chiplet package;
a first wing chiplet neighboring the plurality of central chiplets and disposed in a first peripheral region of the chiplet package; and
a second wing chiplet neighboring the plurality of central chiplets and disposed in a second peripheral region of the chiplet package;
wherein the plurality of central chiplets are disposed between the first and second wing chiplets.

Clause 2: The device of clause 1, wherein the first wing chiplet comprises:
a memory interface;
a first peripheral interface;
a first chiplet interface coupled to a first one of plurality of central chiplets; and
a second chiplet interface coupled to a second one of the plurality of central chiplets.

Clause 3: The device of any preceding clause, wherein the first wing chiplet further comprises:
a second peripheral interface; and
a network interconnecting the memory interface, the first chiplet interface, the second chiplet interface, the first peripheral interface, and the second peripheral interface.

Clause 4: The device of any preceding clause, wherein the network provides a first peer-to-peer connection between the memory interface and the first peripheral interface and a second peer-to-peer connection between the memory interface and the second peripheral interface.

Clause 5: The device of any preceding clause, wherein the first chiplet interface comprises first contacts rotated by 180° with respect to second contacts of the second chiplet interface.

Clause 6: The device of any preceding clause, wherein a first physical layout of the first wing chiplet is rotated by 180° with respect to a second physical layout of the second wing chiplet.

Clause 7: The device of any preceding clause, wherein the first chiplet interface and the second chiplet interface comprise semiconductor bridged chiplet interfaces.

Clause 8: The device of any preceding clause, wherein a first physical layout of a first central chiplet of the plurality of central chiplets is rotated by 180° with respect to a second physical layout of a second central chiplet of the plurality of central chiplets.

Clause 9: The device of any preceding clause, wherein the first central chiplet and the second central chiplet comprise a common circuit design.

Clause 10: A method, comprising:
a device receiving a memory transaction communication, the device comprising:
a chiplet package,
a plurality of central chiplets disposed in a central region of the chiplet package,
a first wing chiplet neighboring the plurality of central chiplets and disposed in a first peripheral region of the chiplet package, and
a second wing chiplet neighboring the plurality of central chiplets and disposed in a second peripheral region of the chiplet package,
wherein the plurality of central chiplets are disposed between the first and second wing chiplets.

Clause 11: The method of clause 10, further comprising:
the device receiving the memory transaction communication at a first peripheral interface of the first wing chiplet; and
the device routing the memory transaction communication across a central chiplet to the second wing chiplet based, at least in part, on a physical memory address associated with the memory transaction communication.

Clause 12: The method of any of clauses 10-11, further comprising:
the device receiving a virtual to physical memory address translation request at a central chiplet, the central chiplet comprising a memory management unit; and
the device responding to the request with a physical memory address for the memory transaction communication.

Clause 13: The method of any of clauses 10-12 wherein the first wing chiplet comprises:
a memory interface;
a first peripheral interface;
a first chiplet interface coupled to a first one of plurality of central chiplets; and
a second chiplet interface coupled to a second one of the plurality of central chiplets.

Clause 14: The method of any of clauses 10-13, wherein the first wing chiplet further comprises:
a second peripheral interface; and
a network interconnecting the memory interface, the first chiplet interface, the second chiplet interface, the first peripheral interface, and the second peripheral interface.

Clause 15: The method of any of clauses 10-14, wherein a first physical layout of the first wing chiplet is rotated by 180° with respect to a second physical layout of the second wing chiplet.

Clause 16: The method of any of clauses 10-15, wherein the network provides a first peer-to-peer connection between the memory interface and the first peripheral interface and a second peer-to-peer connection between the memory interface and the second peripheral interface.

Clause 17: A non-transitory computer-readable medium storing computer-readable code for fabrication of a device comprising:
a chiplet package;
a plurality of central chiplets disposed in a central region of the chiplet package;
a first wing chiplet neighboring the plurality of central chiplets and disposed in a first peripheral region of the chiplet package; and
a second wing chiplet neighboring the plurality of central chiplets and disposed in a second peripheral region of the chiplet package;
wherein the plurality of central chiplets are disposed between the first and second wing chiplets.

Clause 18: The non-transitory computer-readable medium of clause 17, wherein the first wing chiplet comprises:
a memory interface;
a first peripheral interface;
a first chiplet interface coupled to a first one of plurality of central chiplets; and
a second chiplet interface coupled to a second one of the plurality of central chiplets.

Clause 19: The non-transitory computer-readable medium of any of clauses 17-18, wherein the first wing chiplet further comprises:
a second peripheral interface; and
a network interconnecting the memory interface, the first chiplet interface, the second chiplet interface, the first peripheral interface, and the second peripheral interface.

Clause 20: The non-transitory computer-readable medium of any of clauses 17-19, wherein a first physical layout of the first wing chiplet is rotated by 180° with respect to a second physical layout of the second wing chiplet.

Clause 21: A non-transitory computer-readable medium storing computer-readable code for fabrication of a device of any of clauses 1-9.

Clause 22: A non-transitory computer-readable medium storing computer-readable code for performance of a method of any of clauses 10-16.

Clause 23: A method, comprising: receiving a memory transaction communication at a first peripheral interface of a first wing chiplet formed in a first peripheral region of a chiplet package; and routing the received memory transaction communication through at least one central chiplet of the chiplet package to a second wing chiplet formed in a second peripheral region of the chiplet package based, at least in part, on a physical memory address associated with the received memory transaction communication.

Clause 24: The method of clause 23, wherein: the chiplet package comprises a plurality of central chiplets disposed in a central region of the chiplet package neighboring the first and second peripheral regions, and disposed between the first and second peripheral regions.

Clause 25: The method of clause 23 or 24, and further comprising: routing a response to the routed memory transaction communication to the first peripheral interface.

Clause 26: The method of clauses 23 through 24, and further comprising: receiving a virtual to physical memory address translation request at the central chiplet, the central chiplet comprising a memory management unit; and processing the physical memory address translation request at the memory management unit to provide a physical memory address for the memory transaction communication.

Clause 27: The method of clause 23 through 26, wherein the first wing chiplet comprises: a first chiplet interface coupled to a first one of a plurality of central chiplets formed in the chiplet package; and a second chiplet interface coupled to a second one of the plurality of central chiplets.

Clause 28: The method of clause 27, wherein the first wing chiplet further comprises: a memory interface; a second peripheral interface; and a network interconnecting the memory interface, the first chiplet interface, the second chiplet interface, the first peripheral interface, and the second peripheral interface.

Clause 29: The method of clause 28, wherein: a first physical layout of the first wing chiplet is rotated by 180° with respect to a second physical layout of the second wing chiplet; and the network provides a first peer-to-peer connection between the memory interface and the first peripheral interface and a second peer-to-peer connection between the memory interface and the second peripheral interface.

What is claimed is:

1. A device, comprising:
a chiplet package;
a plurality of central chiplets disposed in a central region of the chiplet package;
a first wing chiplet neighboring the plurality of central chiplets and disposed in a first peripheral region of the chiplet package; and
a second wing chiplet neighboring the plurality of central chiplets and disposed in a second peripheral region of the chiplet package;
wherein the plurality of central chiplets are disposed between the first and second wing chiplets.

2. The device of claim 1, wherein the first wing chiplet comprises:
a memory interface;
a first peripheral interface;
a first chiplet interface coupled to a first one of plurality of central chiplets; and
a second chiplet interface coupled to a second one of the plurality of central chiplets.

3. The device of claim 2, wherein the first wing chiplet further comprises:
a second peripheral interface; and
a network interconnecting the memory interface, the first chiplet interface, the second chiplet interface, the first peripheral interface, and the second peripheral interface.

4. The device of claim 3, wherein the network provides a first peer-to-peer connection between the memory interface and the first peripheral interface and a second peer-to-peer connection between the memory interface and the second peripheral interface.

5. The device of claim 2, wherein the first chiplet interface comprises first contacts rotated by 180° with respect to second contacts of the second chiplet interface.

6. The device of claim 5, wherein a first physical layout of the first wing chiplet is rotated by 180° with respect to a second physical layout of the second wing chiplet.

7. The device of claim 2, wherein the first chiplet interface and the second chiplet interface comprise semiconductor bridged chiplet interfaces.

8. The device of claim 1, wherein a first physical layout of a first central chiplet of the plurality of central chiplets is rotated by 180° with respect to a second physical layout of a second central chiplet of the plurality of central chiplets.

9. The device of claim 8, wherein the first central chiplet and the second central chiplet comprise a common circuit design.

10. A method, comprising:
receiving a memory transaction communication at a first peripheral interface of a first wing chiplet formed in a first peripheral region of a chiplet package; and
routing the received memory transaction communication through at least one central chiplet of the chiplet package to a second wing chiplet formed in a second peripheral region of the chiplet package based, at least in part, on a physical memory address associated with the received memory transaction communication.

11. The method of claim 10, wherein:
the chiplet package comprises a plurality of central chiplets disposed in a central region of the chiplet package neighboring the first and second peripheral regions, and disposed between the first and second peripheral regions.

12. The method of claim 10, and further comprising:
routing a response to the routed memory transaction communication to the first peripheral interface.

13. The method of claim 10, and further comprising:
receiving a virtual to physical memory address translation request at the central chiplet, the central chiplet comprising a memory management unit; and
processing the physical memory address translation request at the memory management unit to provide a physical memory address for the memory transaction communication.

14. The method of claim 10, wherein the first wing chiplet comprises:
a first chiplet interface coupled to a first one of a plurality of central chiplets formed in the chiplet package; and
a second chiplet interface coupled to a second one of the plurality of central chiplets.

15. The method of claim 14, wherein the first wing chiplet further comprises:
a memory interface;
a second peripheral interface; and
a network interconnecting the memory interface, the first chiplet interface, the second chiplet interface, the first peripheral interface, and the second peripheral interface.

16. The method of claim 15, wherein:
a first physical layout of the first wing chiplet is rotated by 180° with respect to a second physical layout of the second wing chiplet; and
the network provides a first peer-to-peer connection between the memory interface and the first peripheral interface and a second peer-to-peer connection between the memory interface and the second peripheral interface.

17. A non-transitory computer-readable medium storing computer-readable code for
fabrication of a device comprising:
a chiplet package;
a plurality of central chiplets disposed in a central region of the chiplet package;
a first wing chiplet neighboring the plurality of central chiplets and disposed in a first peripheral region of the chiplet package; and
a second wing chiplet neighboring the plurality of central chiplets and disposed in a second peripheral region of the chiplet package;
wherein the plurality of central chiplets are disposed between the first and second wing chiplets.

18. The non-transitory computer-readable medium of claim 17, wherein the first wing
chiplet comprises:
a memory interface;
a first peripheral interface;
a first chiplet interface coupled to a first one of plurality of central chiplets; and
a second chiplet interface coupled to a second one of the plurality of central chiplets.

19. The non-transitory computer-readable medium of claim 18, wherein the first wing
chiplet further comprises:
a second peripheral interface; and
a network interconnecting the memory interface, the first chiplet interface, the second chiplet interface, the first peripheral interface, and the second peripheral interface.

20. The non-transitory computer-readable medium of claim 17, wherein a first physical layout of the first wing chiplet is rotated by 180° with respect to a second physical layout of the second wing chiplet.
